(19) United States
(12) Patent Application Publication
(10) Pub. No.: US 2004/0241391 A1
(43) Pub. Date: Dec. 2, 2004

(54) Disposable floor mat

(76) Inventor: M. Cristina Levine, Plano, TX (US)

Correspondence Address: Harold Levine, Esq., Suite 755, 101 E. Park Blvd., Plano, TX, 75074, US

(21) Appl. No.: 10/448,703

(22) Filed: May 31, 2003

(51) Int. Cl. B32B 3/10

(52) U.S. Cl. 428/137; 428/122

(57) ABSTRACT

A disposable floor mat specially adapted for use in bathrooms and kitchens, although it may be attractive for other uses such as automobile floor mats. The mat is made of several layers including a backing of plastic or plasticized waterproof material, a tear and scuff resistant exterior layer, and a highly absorbent layer sandwiched between the backing and exterior layers. The exterior layer is adapted to pass moisture to the highly absorbent layer by providing sized apertures therefor. The mats are disposable and preferably mounted in multiple units on a pad from which they can easily be separated as, for example, by tearing along a frangible seam.

### This invention relates to disposable floor mats and more particularly to floor mats having particular usefulness in bathrooms and kitchens.

Disposable door and floor mats have heretofore been proposed, illustrative of which are those disclosed in U.S. Pat. No. 2,057,162 granted to James Richey Oct. 13, 1936; 2,843,868 granted to B. W. Borgstrom Jul. 22, 1958; U.S. Pat. No. 3,517,407 granted to G. W. Wyant Jun. 30, 1970; U.S. Pat. No. 4,125,656 granted to Adelene Creamer Nov. 14, 1978; U.S. Pat. No. 4,285,075 granted to Ann Nelson Aug. 25, 1981; U.S. Pat. No. 4,328,275 granted to Louis Vargo May 4, 1982; U.S. Pat. No. 4,813,944 granted to Glen Haney et al Mar. 21, 1989; U.S. Pat. No. 6,295,658 granted to Matthew Jenkins Oct. 2, 2001; patent publication US2002/0142125 A1 published Oct. 3, 2002; and German Patent Publication DE003203261A1 published Aug. 11, 1983. Also proposals of interest are set forth in U.S. Pat. No. 5,082,707 granted to Michele Fazio Jan. 21, 1992 and U.S. Pat. No. 5,383,570 granted to Terry Gordon Jan. 24, 1995.

Although such proposals have individually addressed certain problems encountered in facilitating bathroom sanitation and deodorization, there yet have remained opportunities for further improvement. Accordingly, there has continued to be a need for improved mats which retain features of low cost and simplicity while maintaining ease of use; and which include, in combination, pluralities of features as set forth below.

### BRIEF SUMMARY OF THE INVENTION

The improved mats according to the invention hereof include simple and cost effective features that facilitate use and disposal. Thus, in accordance with the preferred embodiment hereof, a disposable sanitary mat is provided with three layers. The top layer is smooth and scuff-resistant so as to withstand wear and tear, present relatively low friction with footwear, and facilitate progression of liquids therethrough to an immediately adjoining absorbent layer where such liquids are captured and deodorized. The third, or bottom, layer is moisture impervious so as to prevent progression therethrough from the immediately adjacent absorbent layer. Thus, the improved mat according to the invention comprises three layers which are held together by bonding at selected regions such as, for example, along their edges. The top layer is adapted to facilitate progression of liquids therethrough by provision of an array of minute apertures which are disposed in a predetermined pattern so as to retain scuff and wear resistance while presenting a pleasing esthetic appearance and facilitating moisture progression to the absorbent layer. In contrast with prior proposals which propose pores of no more than 300 microns in diameter, the minute apertures of the present invention are at least an order of magnitude larger, thus facilitating rapid passage of liquids therethrough to the absorbent layer below. Thus according to the invention, there is provided an improved sanitary disposable mat including a combination of attractive features.

### OBJECTS AND FEATURES OF THE INVENTION

It is one general object of the invention to improve sanitary bathroom floor mats.

It is another object of the invention to facilitate progression and retention of undesired fluids.

It is yet another object of the invention to deodorize undesired fluids such as body wastes that may be inadvertently or accidently misdirected adjacent a bathroom commode.

Accordingly, in accordance with one feature of the invention, three cooperating layers having preselected characteristics are adjoined to produce an improved sanitary mat, thus facilitating use.

In accordance with an additional feature of the invention, an upper layer is provided with apertures that are minute, yet large enough to facilitate progression of liquids therethrough, thus facilitating rapid moisture capture and retention by an adjacent absorbent layer.

In accordance with another feature of the invention, the central layer is impregnated with an efficacious deodorizing ingredient, thus facilitating reduction or elimination of undesirable odors.

These and other objects and features of the invention will be apparent from the following description, by way of example of a preferred embodiment, with reference to the drawing.

### BRIEF DESCRIPTION OF THE DRAWING

FIG. 1 is a perspective view depicting a conventional bathroom commode with one of the disposable sanitary mats adjacent thereto;

FIG. 2 is a perspective view depicting the sandwiched construction of the mat and its three cooperating layers; and

FIG. 3 is a perspective view similar to that of FIG. 2 but showing representative ones of the aforementioned apertures.

FIG. 4 is a perspective view showing a plurality of mats in a convenient pad from which mats can individually be easily detached for use.

### DESCRIPTION OF A PREFERRED EMBODIMENT

Before proceeding with a detailed description of the preferred embodiment, there are now set forth the following definitions as they are employed in the specification and claims hereof.

Scuff resistant material means material having sufficient resistance to abrasion as to maintain its integrity as a protective layer after it has normally been stepped upon by conventional footwear at least 10 times.

Tear resistant material means material exhibiting the quality of being resistant to tearing.

Relatively thin means being on the order of one-half or less in width than the width of an adjacent absorbent layer.

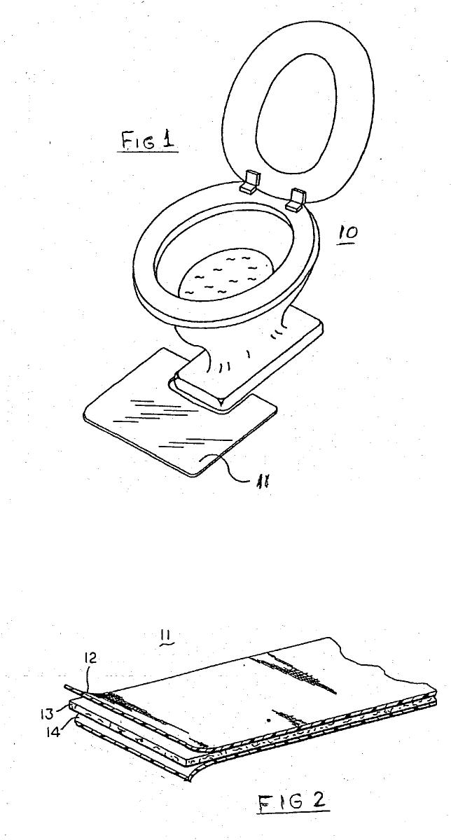

Now turning to the drawing, and more particularly FIG. 1 thereof, it will be seen to be a perspective view depicting a conventional bathroom commode 10 adjacent which is disposed a sanitary deodorizing disposable mat 11. Mat 11 preferably is formed in a generally U-shaped configuration so as to partially extend along the sides of the commode base as shown. However, it will be evident that it could be rectangular (e.g., for kitchen use) or arcuate if desired. When in the position as shown, undesirable fluids (e.g., body or kitchen waste fluids) that otherwise might fall on carpet or other floor covering underlying the mat would be protected therefrom since they will fall on the upper surface of mat 11 and be captured therein.

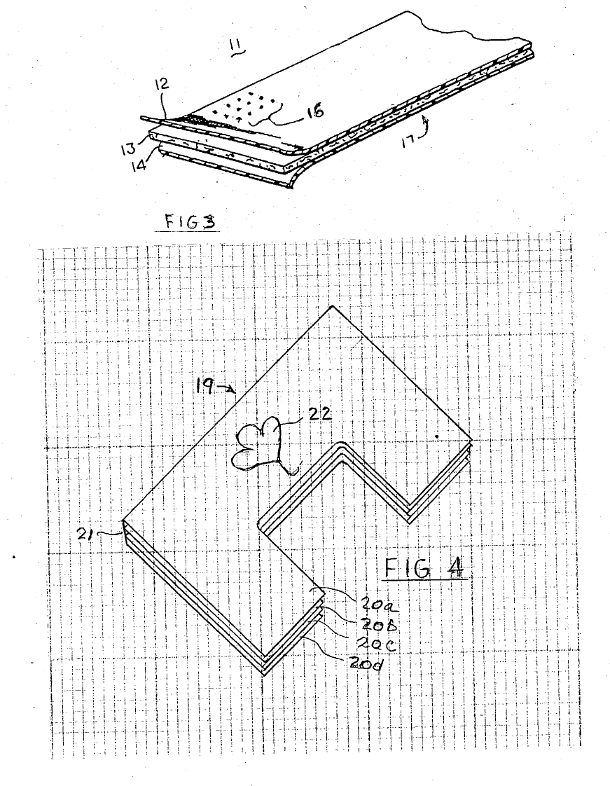

FIG. 2 is a perspective view showing the three layers of mat 11 as mentioned above. Layer 12 is of scuff and tear resistant material (e.g., including polymer materials such as polyethylene, polyester, polypropylene) and would be impervious to fluids such as water were it not for the inclusion of a plurality of small apertures as depicted and described in connection with FIG. 3. These apertures whose largest dimension is at least 3000 microns (preferably more) and optimally being in a range of from about 3,000 to 10,000 microns (3 to 10 millimeters), facilitate passage of liquids therethrough to center layer 13 which is of material selected for its moisture capturing and retention qualities. Center layer 13 is preferably of at least twice the thickness as that of either of the adjacent layers 12 and 14.

Now turning to FIG. 3, it will be seen to be a perspective view similar to that of FIG. 2 but showing representative ones of the aforementioned apertures 16 which extend through the body of upper thin layer 12 and which facilitate passage of fluids therethrough. For purposes of simplicity and clarity, only representative ones of the apertures are shown, it being understood that most or all of the upper surface will include such apertures. In addition, it should be noted that optimum spacing between the apertures is correlated with their respective sizes, it being desired to provide sufficient spacing to retain acceptable scuff and tear resistance while maintaining good liquid transfer to the underlying absorbent layer 13.

It should also be understood that any of a plurality of techniques well known to those skilled in the art can be employed to hold the layers 12, 13 and 14 in engagement. Thus, for example the edges (e.g., edge 17) may be held together by adhesive materials or, in some instances in which the materials of the layers liquify at manageable temperatures, by simply heating the edges until they bond.

It will also be evident that mats constructed in accordance with the foregoing are well suited for packaging together in so-called tear-off packages. In such instance, the mats are mounted in multiple units on a pad from which they can easily be separated as, for example, by tearing along a frangible seam (shown as element 21 and described below). FIG. 4 illustrates such a pad. There, it will be seen is a pad 19 of mats, four of which are shown as mats 20a, 20b, 20c and 20d. These mats may be joined together to form the pad by any of a variety of ways known to those skilled in the art. However, in the preferred embodiment hereof, they are joined along their rear edges by frangible strip 21, one end of which is depicted in FIG. 4. Also shown in FIG. 4 is a flower ornamentation 22 which is optionally included to add esthetic appeal and attractiveness.

It will now be evident that there has been described herein improved disposable mats that are particularly, though not exclusively, suited for use in bathrooms and kitchens.

Although the invention has been described by way of a preferred embodiment, it will be evident that adaptations and modifications may be employed without departing from the spirit and scope thereof. For example, the above-described apertures may be disposed in ornamental patterns, e.g., floral patterns, thus advantageously adding another element of visual esthetics to the pads and/or mats.

The terms and expressions employed herein have been used as terms of description and not of limitation; and thus, there is no intent of excluding equivalents, but on the contrary it is intended to cover any and all equivalents that may be employed without departing from the spirit and scope of the invention.

What is claimed is:

1. A disposable floor mat having two principal exterior surfaces, said mat comprising:
(a) a first relatively thin layer of moisture-impervious material presenting a bottom one of said surfaces;
(b) a second relatively thin layer of protective material presenting the other of said surfaces, said second layer having an array of minute apertures each presenting an opening of at least 3000 microns in width; and
(c) a third layer of absorbent material sandwiched between said first and said second layers;

2. A disposable floor mat according to claim 1 wherein said third layer includes a deodorizer.

3. A disposable floor mat according to claim 1 wherein material of said first relatively thin layer includes a polymer

4. A disposable floor mat according to claim 3 wherein material of said first relatively thin layer includes polyethylene.

5. A disposable floor mat according to claim 3 wherein material of said first relatively thin layer includes polyester.

6. A disposable floor mat according to claim 3 wherein material of said first relatively thin layer includes polypropylene.

7. A disposable floor mat according to claim 1 wherein material of said second relatively thin layer is tear resistant.

8. A disposable floor mat according to claim 1 wherein exposed surfaces of said second relatively thin layer are scuff resistant.

9. A disposable floor mat according to claim 1 wherein said apertures are essentially circular.

10. A disposable floor mat according to claim 1 wherein said mat is essentially U-shaped.

11. A disposable floor mat according to claim 1 wherein material of said third layer includes a deodorizer.

12. A disposable floor mat according to claim 11 wherein said deodorizer includes perfume.

13. A disposable floor mat according to claim 1 wherein said apertures are disposed in an mental pattern.

14. A disposable floor mat according to claim 13 wherein said ornamental pattern is floral.

15. A plurality of mats according to claim 1 wherein said plurality of mats are mounted on a support and in which said plurality includes frangible means for separating said mats from said support and from each other.
